(19) United States
(12) Patent Application Publication
(10) Pub. No.: US 2007/0175320 A1
(43) Pub. Date: Aug. 2, 2007

(54) Accelerated Aging Process for Acoustic Stringed Instruments

(75) Inventors: James Hall, Tampa, FL (US); Daniel P. Hess, Lutz, FL (US)

Correspondence Address: SMITH HOPEN, PA, 180 PINE AVENUE NORTH, OLDSMAR, FL, 34677, US

(73) Assignee: UNIVERSITY OF SOUTH FLORIDA, Tampa, FL (US)

(21) Appl. No.: 11/668,031

(22) Filed: Jan. 29, 2007

Related U.S. Application Data
(60) Provisional application No. 60/763,021, filed on Jan. 27, 2006.

(51) Int. Cl. G10H 3/00

(52) U.S. Cl. 84/723

(57) ABSTRACT

A method of artificially aging a musical instrument is provided by placing the instrument in an enclosure, providing at least one electromechanical transducer proximate to the instrument and providing an electrical signal to the transducer. The transducer is a three-way speaker in a preferred embodiment. The method has particular utility wherein the instrument is a wooden, stringed instrument.

### CROSS REFERENCE TO RELATED APPLICATIONS

This application claims priority to U.S. Provisional Application 60/763,021 filed on Jan. 27, 2006, which is incorporated herein by reference.

### BACKGROUND OF THE INVENTION

It is known that stringed instruments are enhanced with age, specifically from actual playing-time (or use). The wood used to construct the instruments provides a more pleasing result the more it is vibrated. It is for this reason that such a high value is placed on vintage instruments.

The vibration associated with use of the instrument causes subtle changes in the pliability of the wood. Vibration has equal effects on the natural resins within the wood. Moreover, finishes such as lacquer, commonly applied to wooden stringed instruments, are effected by vibration resulting in the loss of plasticizers. These changes usually take many years.

Others have sought to shorten the time needed to gain the desired effects of aging. For example, U.S. Pat. No. 2,911,872 describes a motor powered apparatus which mechanically bows the strings of a violin. The system can be set up such that the strings can be played at any selected position and bowed in succession. U.S. Pat. No. 5,031,501 describes a device comprising a small shaker which is attached to the sound board of a stringed instrument. The shaker is then driven by a musical signal to simulate what the sound board experiences as it is being played. These approaches both provide automatic means to simulate playing the instrument, thus allowing the instrument to be aged without the expenditure of time or effort by a real musician. However, both approaches take a prolonged period of time to age a new instrument because they basically simulate playing the instrument; aging occurs in real time.

U.S. Pat. No. 5,537,908 developed a process for wooden stringed instruments that utilizes broadband vibration from a large electromagnetic shaker and controller. The instrument is attached to a specially designed shaker fixture and then subjected to broadband vibration excitation. The broadband input provides excitation over the frequency range of 20 to 2,000 Hz, providing accelerated aging compared to single tone inputs from earlier methods. Experienced musicians attested to hearing improvement in sound producing ability after application of this method. In addition, simple vibration measurements showed an increase in instrument response. The process, however, requires direct contact or coupling with a large electromagnetic shaker which can and result in damage to the instruments processed. In addition, the upper frequency limit of such shakers is about 2,000 Hz.

### SUMMARY OF INVENTION

In one embodiment, the invention includes a method of artificially aging an instrument by placing the instrument in an enclosure, providing at least one electromechanical transducer proximate to the instrument and providing an electrical signal to the transducer. The transducer is a three-way speaker in a preferred embodiment. The method has particular utility wherein the instrument is a wooden, stringed instrument.

In an alternate embodiment, wherein the instrument is a wooden, stringed instrument, at least one electromechanical transducer is provided proximate the body of the instrument and another electrochemical transducer is provided proximate the neck of the instrument. This allows excitation of the instrument when a broadband signal is amplified and passed through the transducer.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view of an illustrative device for implementing the inventive method.

FIG. 2 is a side view of the illustrative device of FIG. 1.

FIG. 3A is the formula for calculating the average power and cross spectra.

FIG. 3B is the formula for computing frequency response.

FIG. 3C is the formula for calculating coherence γ²(f) as a function of frequency.

FIG. 4A is a graph showing representative initial and final (i.e., before and after) frequency response data for a sample violin.

FIG. 4B is a graph showing the change or difference in magnitude after the aging treatment.

FIG. 5 shows graphs of the change or difference in measured frequency response magnitude after the aging treatment for four additional sample violins.

FIG. 6 shows graphs of the change or difference in measured frequency response magnitude after the aging treatment for three sample guitars.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

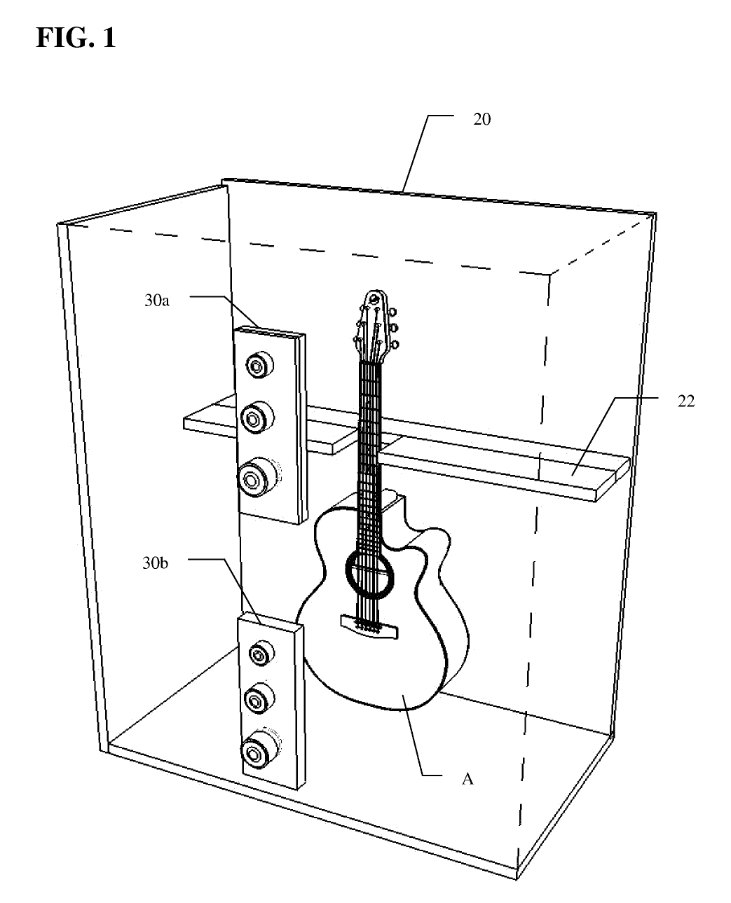

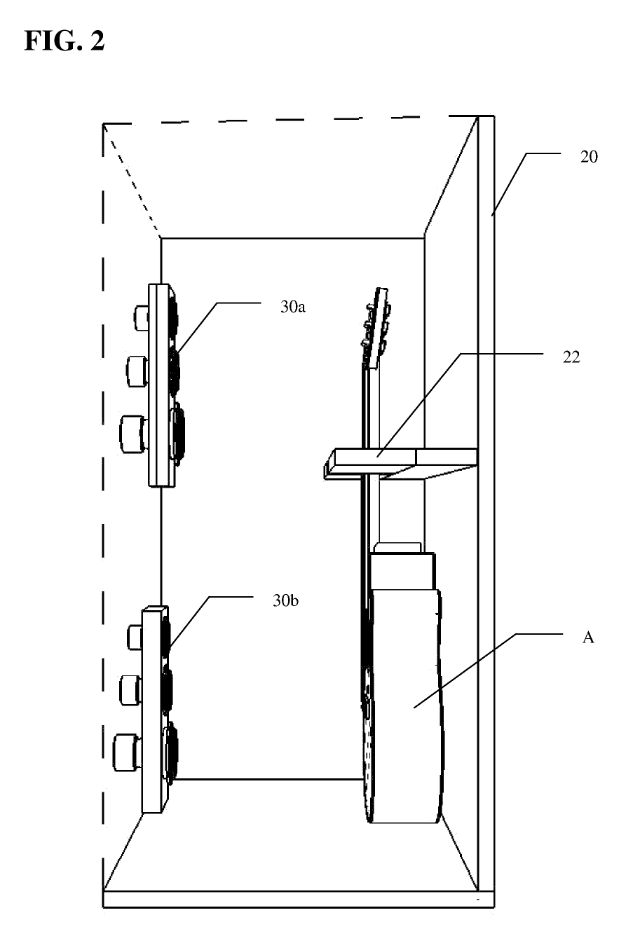

This invention provides a method for the accelerated aging of instruments, particularly wooden stringed instruments, and for quantifying this phenomenon using formal frequency response analyses. The excitation is non-contact and broadband over a more complete frequency range of 20 to 20,000 Hz. An illustrative device for employing the inventive method is disclosed in FIGS. 1 and 2. Instrument A is suspended in enclosure 20. The enclosure can be mobile, resembling a box or case, or can be room specifically adapted for the accelerated aging of multiple instruments or large instruments such as a piano. In FIG. 1, the enclosure (20) is a box (with most of sides omitted for ease of viewing). Instrument A is a guitar suspended in enclosure 20 at the neck by support 22. Padding can be used to isolate instrument A from support 22 and to protect its surface. Enclosure 20 can be constructed from any suitable material, including inexpensive materials such as medium density fiberboard. Electromechanical transducers, such as speakers 30a and 30b, are positioned to subject instrument A to the sound waves created thereby. In one embodiment, a pair of speakers are utilized with one speaker 30a facing the front body of instrument A and the second speaker 30b facing the instrument's neck. Speakers 30 are driven with a broadband signal through a power amplifier (not shown). The preferred embodiment is capable of providing broadband sound levels of at least 110 dB without clipping or distortion. The speakers and amplifier are adapted to run continuously for days or weeks at a time.

Test instruments were assessed before and after the acoustic treatment. Experienced musicians provided subjective input on test instruments and found significant improvement with respect to response, playability, and ease of tuning. In addition, frequency response data computed from impact testing using a miniature soft tipped impact hammer and a miniature accelerometer revealed significant improvements in measured response.

Frequency Response

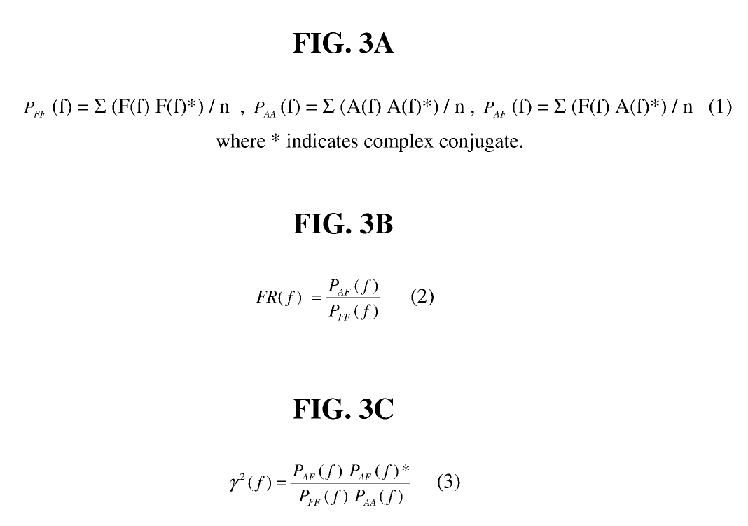

Frequency response, FR(f), is defined with the impact force F (in units of Newtons, N) to the instrument as the input and the resulting vibratory acceleration A (in units of g) of the instrument sound board as the output. It is calculated using a two-channel dynamic signal analyzer as follows. Time trace measurements of the dynamic input and output are obtained, these measurements are windowed, and the fast Fourier transforms of these windowed time traces are computed. This is repeated at least 8 times, and the average power and cross spectra are computed as using equation (1) in FIG. 3A. The frequency response is then computed using equation (2) in FIG. 3B.

The magnitude of the response function is presented graphically in g/N versus frequency. Coherence is also computed to assess the validity of the measurement. Coherence provides a measure of the power in the test instrument vibration that is caused by the power in the impact force. A coherence of 1 means that all of the vibratory acceleration is caused by the impact force, whereas a coherence of 0 means that none of the vibration is caused by the force. The coherence γ²(f) is a function of frequency and is computed using equation (3) (FIG. 3C).

Acoustic Treatment Results

Tests with several sample violins and guitars were performed. The instruments were subjected to the acoustic treatment, as describe above, continuously for several weeks using pink noise broadband input. The instruments were assessed both before and after the treatment by experienced musicians and through frequency response measurements.

The musicians noticed a vast improvement in the tonal quality (warmer), responsiveness (increased response), and ease of tuning. The improved ease in tuning is of special interest because new instruments (especially lower-end string instruments) are very difficult to get and keep in tune.

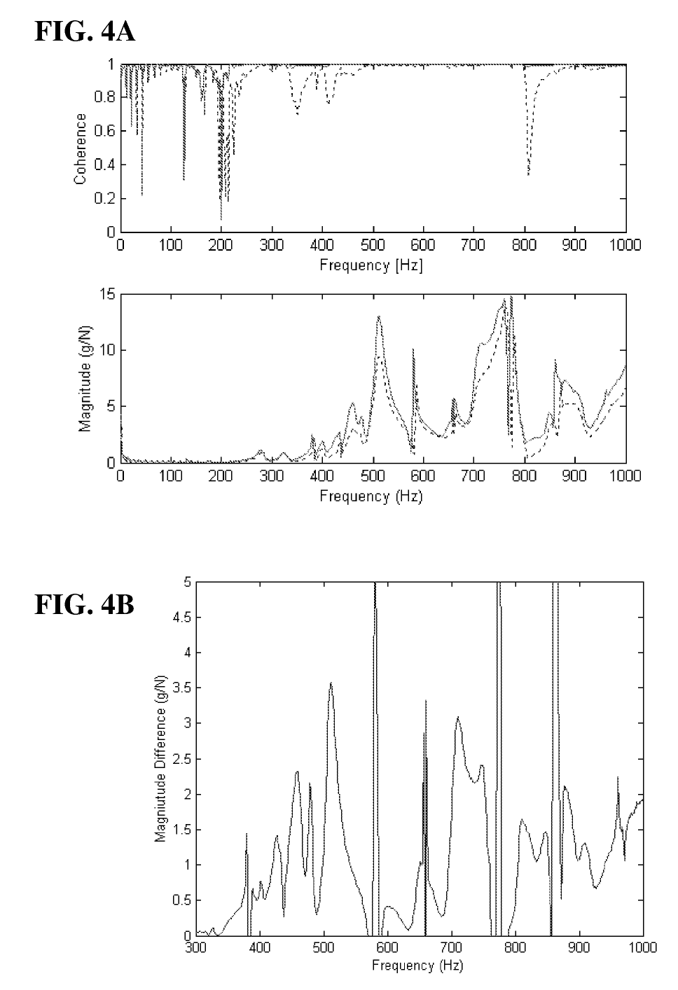

FIG. 4A shows representative initial and final (i.e., before and after) frequency response data from a sample violin. The coherence shows that most of the response is due to the input over most of the frequency range assessed. The magnitude is notably higher following the aging treatment. This is highlighted in FIG. 4B which shows the difference in magnitude. This data clearly shows that the instrument yields more vibratory response (g) per unit input (N) over most of the frequency range. This is consistent with one of the findings observed independently from experienced musicians.

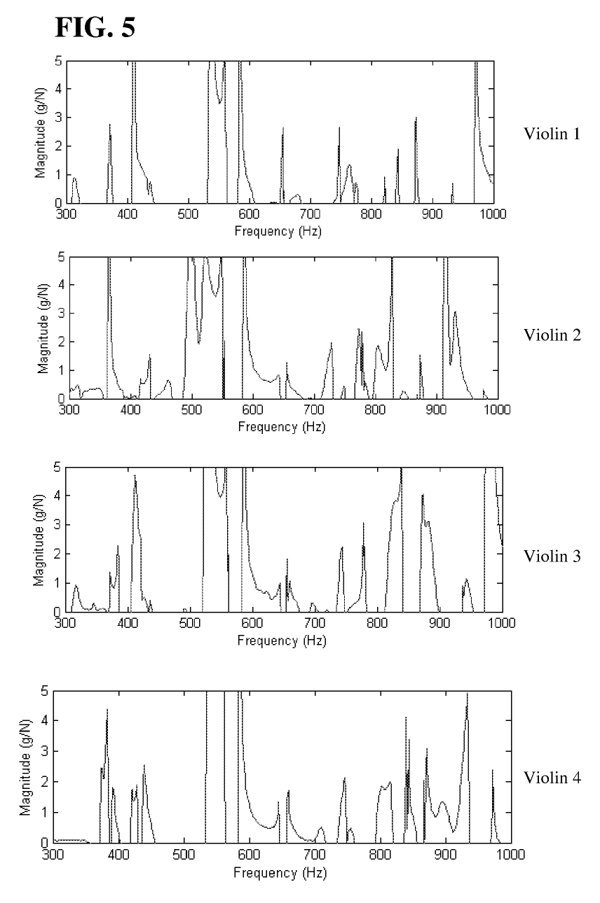

Additional tests were performed on four additional violins and three guitars. All instruments tested showed an increase in vibratory response. FIG. 5 shows the change or difference in measured frequency response magnitude after aging treatment for four sample violins. A positive magnitude change means that the instruments produce more sound, or responds more for the same energy input; a significant aspect of this process. The violins used for testing ranged in quality from very cheap ($150.00) to moderately priced ($1200.00) with the building quality commensurate with the price paid.

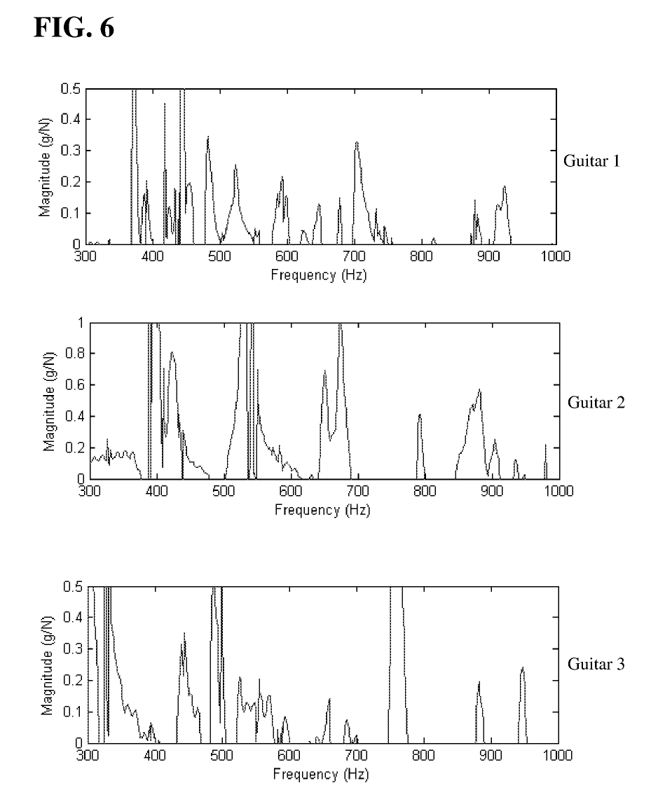

The change in measured frequency response magnitude after the aging treatment for three sample guitars is shown in FIG. 6. Even though the magnitude change is less than observed for the violins, an increase of 0.5 to 1.0 g/N is still significant.

As used herein, the term electromechanical transducer refers to any device that converts one type of energy to another, such as converting electricity into sound waves. In an illustrative embodiment, the electromechanical transducer is a three-way speaker comprising three drivers: large for the bass, midsize for the midrange frequencies, and small for the high frequencies.

As used herein, the term broadband refers to a signaling method which includes or handles a relatively wide range of frequencies, about 20 to 20,000 Hz, which may be divided into channels.

As used herein, the term stringed-instrument refers to any musical instrument that produces sound by means of vibrating strings, such as those in the violin, guitar and piano families.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A method of artificially aging an instrument, comprising the steps of:
placing the instrument in an enclosure;
providing at least one electromechanical transducer proximate to the instrument; and
providing an electrical signal to the transducer.

2. The method of claim 1 wherein the transducer is a speaker.

3. The method of claim 2 wherein the speaker is a three-way speaker.

4. The method of claim 1 wherein the instrument is a wooden, stringed instrument.

5. The method of claim 4 wherein at least one electromechanical transducer is provided proximate the body of the instrument.

6. The method of claim 4 wherein at least one electromechanical transducer is provided proximate the neck of the instrument.

7. The method of claim 1 wherein the electrical signal is a broadband signal.

8. The method of claim 1 wherein the electrical signal is amplified.

9. A device for artificially aging an instrument, comprising:
an enclosure adapted to contain the instrument;
at least one electromechanical transducer proximate to the instrument when it is placed within the enclosure; and
a power source adapted to provide electricity to the at least one electromechanical transducer.

10. The device of claim 9 wherein the transducer is a speaker.

11. The device of claim 10 wherein the speaker is a three-way speaker.

12. The device of claim 9 wherein the instrument is a wooden, stringed instrument.

13. The device of claim 12 wherein at least one electromechanical transducer is provided proximate the body of the instrument.

14. The device of claim 13 wherein at least one electromechanical transducer is provided proximate the neck of the instrument.

15. The device of claim 9 wherein the power source provides a broadband signal.

16. The device of claim 9 further comprising an amplifier.
